(19) United States
(12) Patent Application Publication
(10) Pub. No.: US 2024/0007392 A1
(43) Pub. Date: Jan. 4, 2024

(54) OPPORTUNISTIC LABEL SWITCHED PATHS TO ENSURE ACCEPTABLE APPLICATION EXPERIENCE

(71) Applicant: Cisco Technology, Inc., San Jose, CA (US)

(72) Inventors: Jean-Philippe Vasseur, Saint Martin d'Uriage (FR); Grégory Mermoud, Venthône (CH); Mukund Yelahanka Raghuprasad, San Jose, CA (US)

(21) Appl. No.: 17/853,167

(22) Filed: Jun. 29, 2022

(51) Int. Cl. H04L 45/00; H04L 45/24; H04L 45/50; H04L 45/42; H04L 45/12; H04L 45/302

(52) U.S. Cl. CPC H04L 45/22; H04L 45/24; H04L 45/50; H04L 45/42; H04L 45/123; H04L 45/302

(57) ABSTRACT

In one embodiment, a device obtains quality of experience measurements for an online application having application traffic conveyed via a first path in a backbone network between an ingress point and an egress point in the backbone network. The device makes a determination that the quality of experience metrics are indicative of degraded user experience with the online application. The device causes a label switched path to be scheduled between the ingress point and the egress point in the backbone network. The device causes at least a portion of the application traffic for the online application to be sent via the label switched path instead of the first path.

### TECHNICAL FIELD

The present disclosure relates generally to computer networks, and, more particularly, to opportunistic label switched paths (LSPs) to ensure acceptable application experience.

### BACKGROUND

Today, service provider backbone networks rely on Layer-3 metrics and techniques, to make routing decisions. More specifically, the topology of the backbone network is represented as a graph having links weighted using static metrics. For example, in the case of Interior Gateway Protocols (IGPs) such as Open Shortest Path First (OSPF) and Intermediate-System-to-Intermediate-System (ISIS), each link is assigned with a static metric representing the bandwidth (link speed), the delay, or any other combination of Layer-3 metrics. However, regardless of the Layer-3 routing approach used, no consideration is given in the provider backbone network to the actual effects of the routing decisions on the application whose traffic is routed via the backbone network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture to schedule opportunistic label switched paths (LSPs) to ensure acceptable application experience;

FIGS. 6A-6B illustrate an example of an LSP being scheduled in a backbone network; and

FIG. 7 illustrates an example simplified procedure to schedule opportunistic LSPs in a backbone network to ensure acceptable application experience.

### DESCRIPTION OF EXAMPLE EMBODIMENTS

### Overview

According to one or more embodiments of the disclosure, a device obtains quality of experience measurements for an online application having application traffic conveyed via a first path in a backbone network between an ingress point and an egress point in the backbone network. The device makes a determination that the quality of experience metrics are indicative of degraded user experience with the online application. The device causes a label switched path to be scheduled between the ingress point and the egress point in the backbone network. The device causes at least a portion of the application traffic for the online application to be sent via the label switched path instead of the first path.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

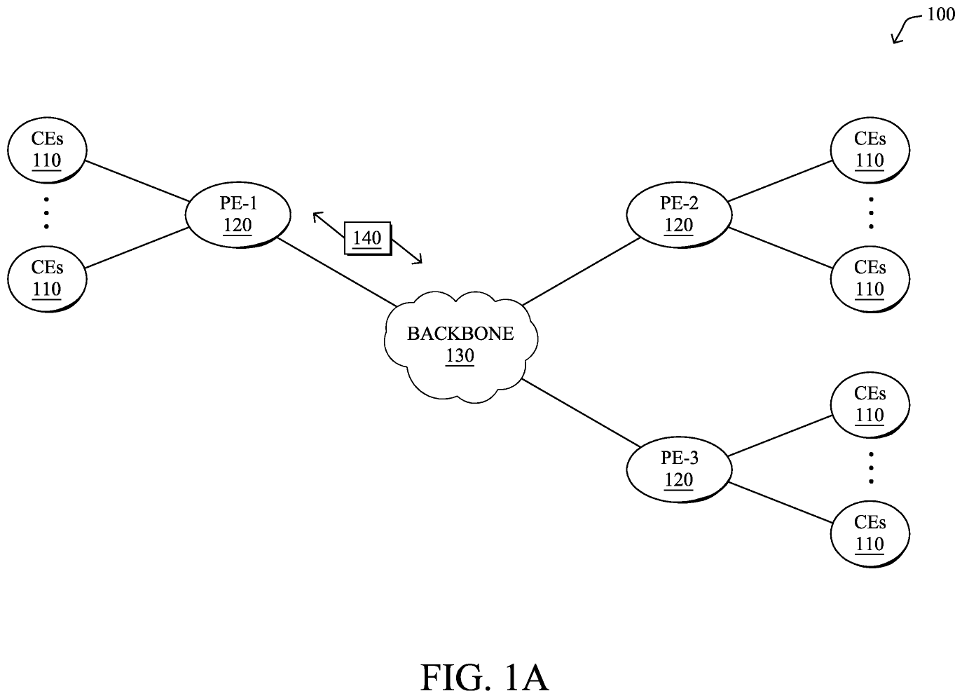

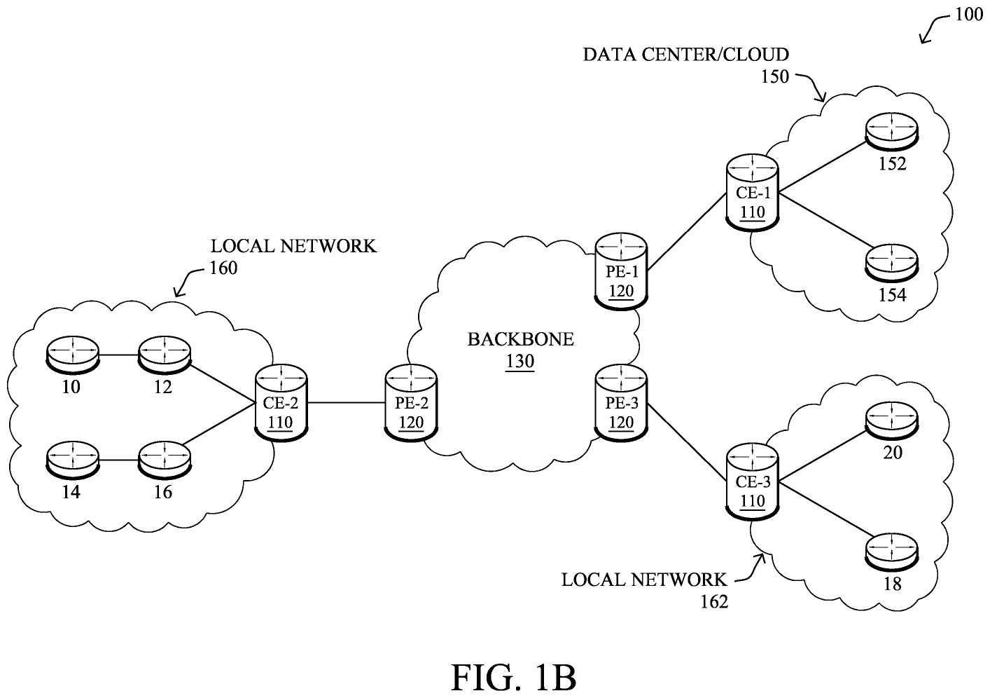

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative backbone network 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, backbone network 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone network 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

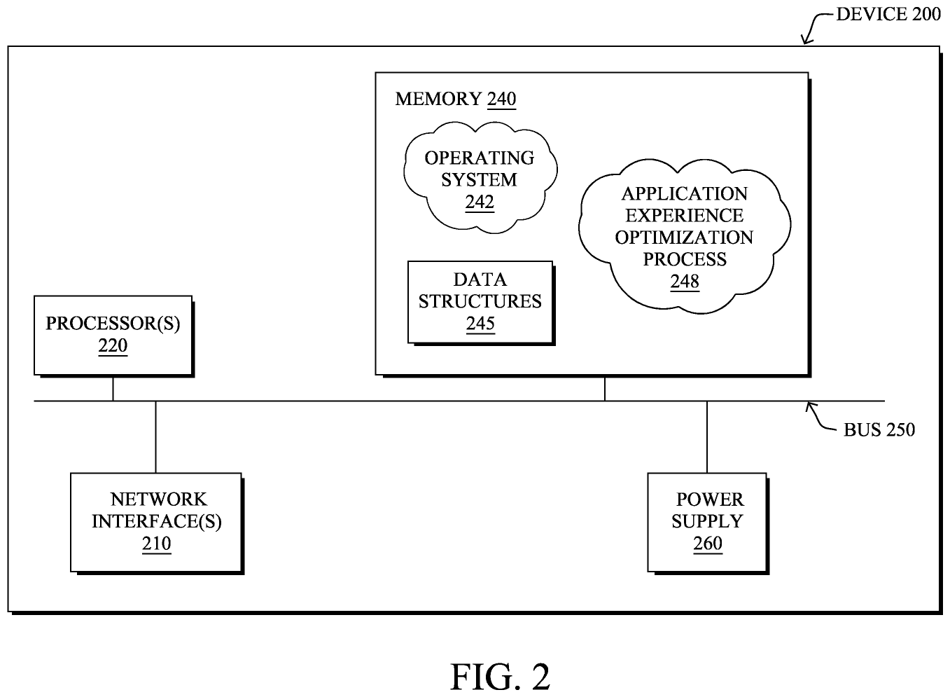

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an application experience optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, application experience optimization process 248 may include computer executable instructions that, when executed by processor(s) 220, cause device 200 to perform the techniques described herein. To do so, in some embodiments, application experience optimization process 248 may utilize artificial learning/machine learning. In general, artificial intelligence/machine learning is concerned with the design and the development of techniques that take as input empirical data (such as network statistics and performance indicators), and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, application experience optimization process 248 may employ one or more supervised, unsupervised, or semi-supervised machine learning models. Generally, supervised learning entails the use of a training set of data, as noted above, that is used to train the model to apply labels to the input data. For example, the training data may include sample data that has been labeled as indicative of acceptable user experience or poor user experience. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that application experience optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

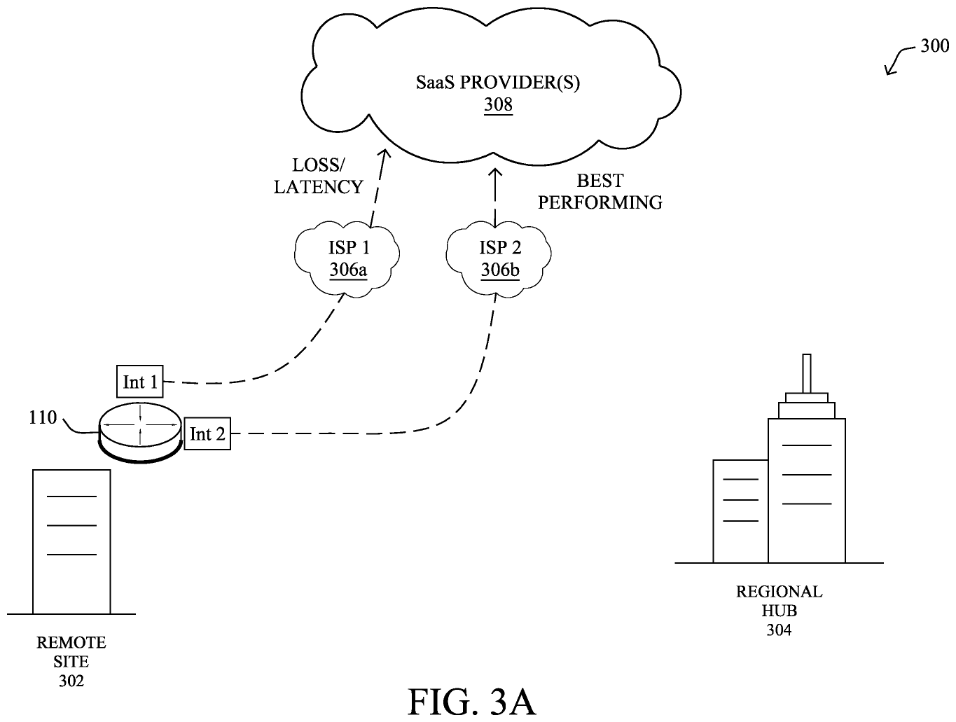

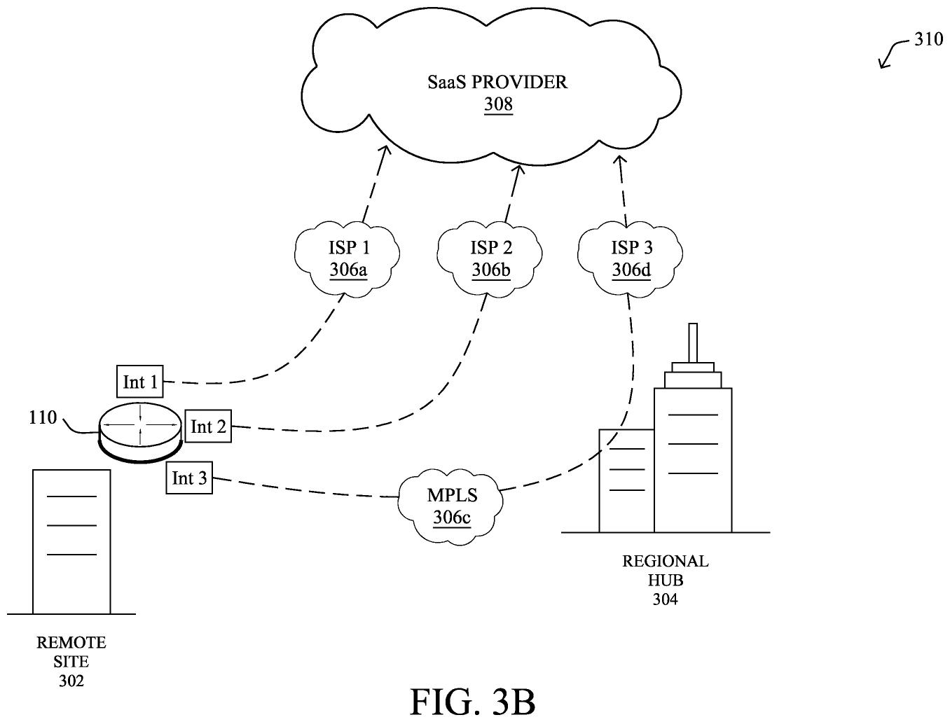

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

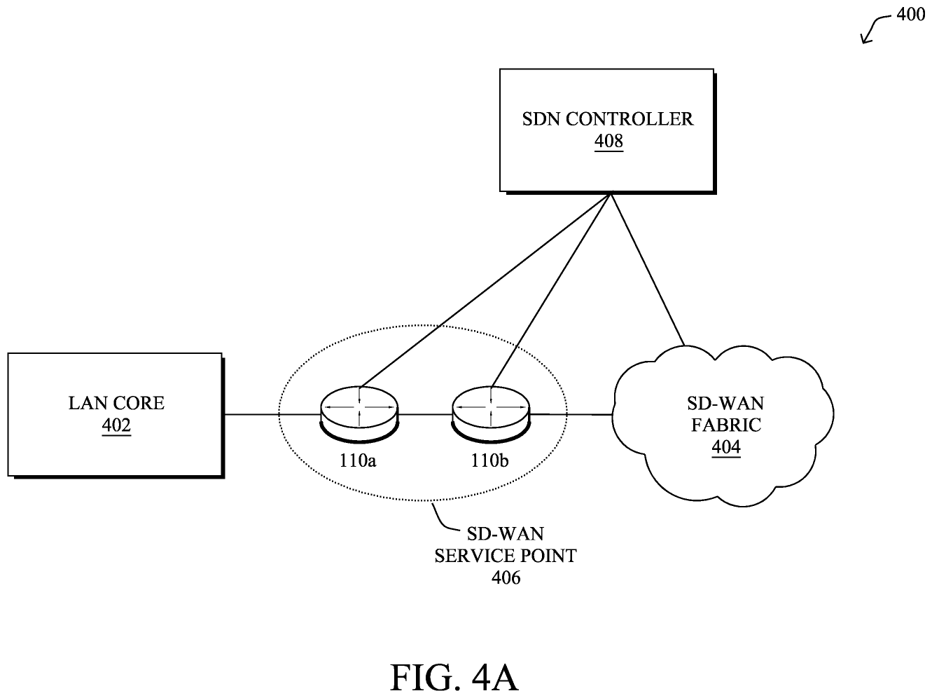

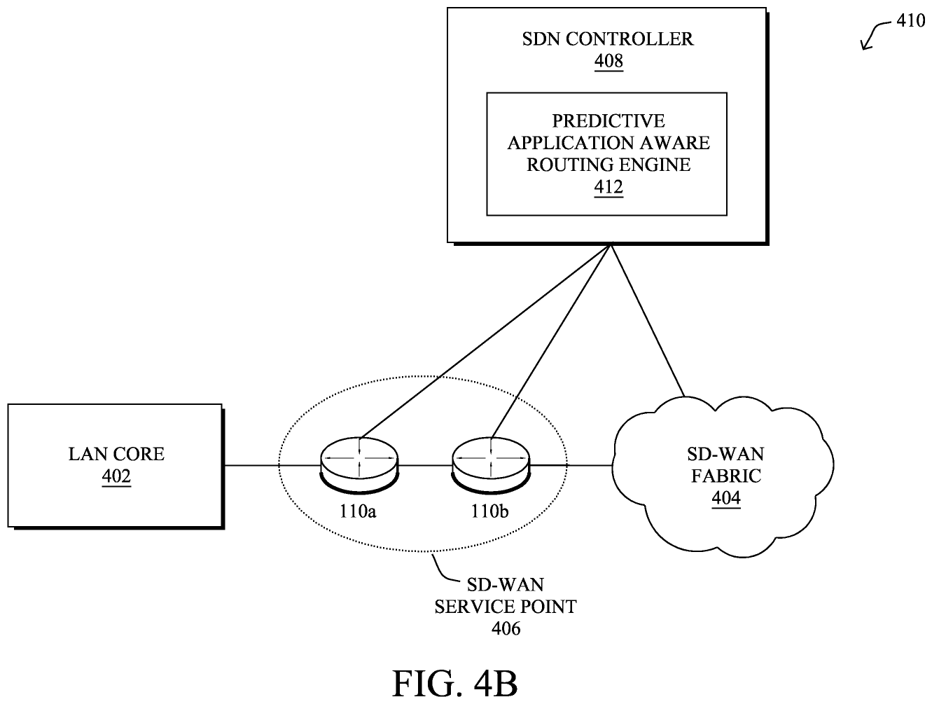

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

A primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application (i.e., the user experience).

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given dine, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of application experience optimization process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy for actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As would be appreciated, modern SaaS applications are typically delivered globally via public cloud infrastructure: using cloud native services. Even though public cloud providers may have a high number of points of presence (PoPs) and use those to deliver the application, globally. Still, testing has shown that user quality of experience (QoE) may vary greatly based on the location of the user. This is because all public cloud providers are delivering services which are region-based and applications are running in specific region(s) and location(s). Indeed, even though it might seem that an online application is global (e.g., because of its use of globally-available CloudFront POPs, etc.), in reality it might run in a single region/location and user experience might vary greatly based on the location.

To determine the QoE for a particular SaaS application, various approaches are possible such as:
Obtaining user feedback directly from the application
Applying traffic analytics, such as by analyzing Netflow records that include extra metrics like Application Response Time (ART)
Sending synthetic path probes to measure networking metrics to each SaaS application from each location. These probes are ‘synthetic’ in that they seek to mimic the actual characteristics of the traffic of the application under scrutiny.
Using hand-crafted heuristics based on domain expertise and other quantities (e.g., the concealment time)

In various embodiments, predictive application aware routing engine 412 may make use of any or all of the above approaches. For instance, predictive application aware routing engine 412 may make use of an API for a particular online application, allowing it to obtain application experience/QoE metrics directly from the application. Such metrics may be combined with probing results and/or path telemetry. This is in sharp contrast to network-centric approaches that do not necessarily reflect the true user experience.

As noted above, today, service provider backbone networks rely on Layer-3 metrics and techniques, to make routing decisions. More specifically, the topology of the backbone network is represented as a graph having links weighted using static metrics. For example, in the case of Interior Gateway Protocols (IGPs) such as Open Shortest Path First (OSPF) and Intermediate-System-to-Intermediate-System (ISIS), each link is assigned with a static metric representing the bandwidth (link speed), the delay, or any other combination of Layer-3 metrics. Multi-topology routing then extended this notion by allowing multiple topologies where links could have multiple (still static) metrics. Traffic could then be routed along the appropriate topology optimized for a given link metric. Other techniques such as Multiprotocol Label Switching—Traffic Engineering (MPLS TE) evolved to allow the use of labeled switched path (LSPs) computed using constrained-based routing (find the shortest path according to some static metric that provides at least X Mbps of bandwidth) using a mechanism of control plane (not data plane) reservation.

Still, all of the traditional routing approaches in a provider backbone network perform routing decision using static metrics without considering the measured application experience. At best, probing mechanisms are used to check the application SLA using (Layer-3) probing to statically change path selection by tuning the IGP metric or changing the TE LSP constraints (e.g., reserve more bandwidth), taking a “trial-and-error” offline approach.

Predictive routing, such as that performed by predictive application aware routing engine 412, allows the Internet to be endowed with learning capabilities thanks to the use of statistical and machine learning models. Such models can be used for encoding path characteristics and expected path performances with regards to specific application SLA requirements. Predictions can then be made with various forecasting horizons (predicting few seconds before a potential failure, few hours in advanced (current approach) or even trends few weeks ahead). More specifically, predictive application aware routing engine 412 may predict “application failures” which correspond to an abrupt degradation of user experience to levels that make the application unusable or unacceptable. Such application failures may, for instance, be defined as drastic increases in the percentage of time spent outside of a predefined SLA template (e.g., delay <300 ms, jitter <50 ms, etc.). If the percentage of time spent outside of the template increases from, say, 2% to 10%, this can have a significant impact on the user experience. Thus, the objective of predictive application aware routing engine 412 is to predict and avoid such application failures.

Said differently, current technologies related to routing in large (service provider/enterprise) backbone networks make use of static Layer-3 metric to route traffic on (constrained) shortest paths. The actual Quality of Experience (QoE) reflecting the user experience is never considered for routing/forwarding decision. At best, a posteriori off-line monitoring is used to then detect potential issue and re-engineer the network using IGP/MPLS TE traffic engineering

### Opportunistic Label Switched Paths to Ensure Acceptable Application Experience

The techniques introduced herein provide for the scheduling of new paths (e.g., LSPs) in a backbone network according to the observed application SLAs/quality of experience metrics, in contrast with existing routing techniques where the networking and applications layers are simply not tied. In some aspects, a policy engine is used to specify the set of critical applications benefiting from this invention along with the SLA criterion that must be met. In further aspects, the application QoE is obtained and, on detection of a violation, computation of an alternate path using a TE LSP or other source routed path can be triggered between the ingress and egress routers of the backbone, that is then used to divert some traffic from the existing path, thus removing the SLA violation condition.

Illustratively, the techniques described herein may be performed by hardware, software, and/or firmware, such as in accordance with application experience optimization process 248, which may include computer executable instructions executed by the processor 220 (or independent processor of interfaces 210) to perform functions relating to the techniques described herein.

Specifically, according to various embodiments, a device obtains quality of experience measurements for an online application having application traffic conveyed via a first path in a backbone network between an ingress point and an egress point in the backbone network. The device makes a determination that the quality of experience metrics are indicative of degraded user experience with the online application. The device causes a label switched path to be scheduled between the ingress point and the egress point in the backbone network. The device causes at least a portion of the application traffic for the online application to be sent via the label switched path instead of the first path.

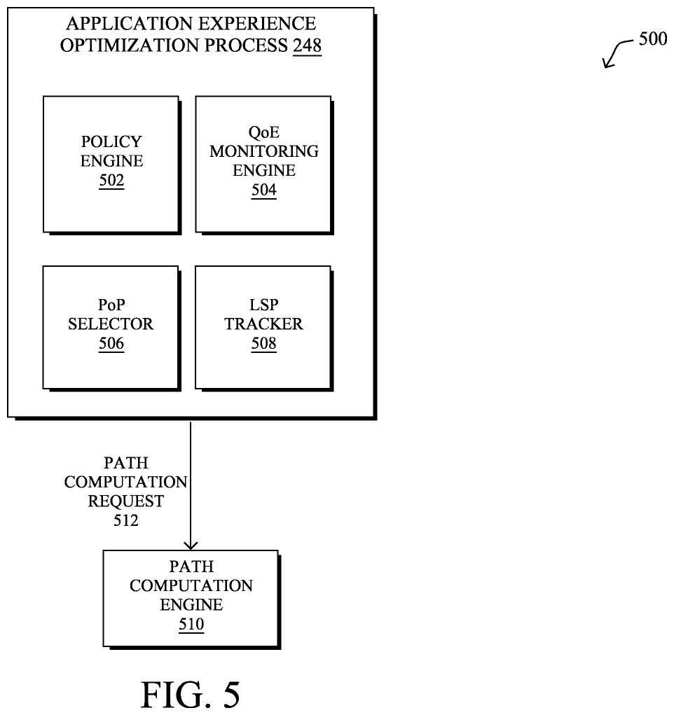

Operationally, FIG. 5 illustrates an example architecture to schedule opportunistic label switched paths (LSPs) to ensure acceptable application experience, according to various embodiments. At the core of architecture 500 is application experience optimization process 248, which may be executed by a controller for a network or another device in communication therewith. For instance, application experience optimization process 248 may be executed by a controller for a network (e.g., SDN controller 408 in FIGS. 4A-4B, a path computation element, etc.), a particular networking device in the network (e.g., a router, etc.), another device or service in communication therewith, or the like. In further embodiments, architecture 500 may be implemented as part of a secure access service edge (SASE) deployment.

As shown, architecture 500 may include any or all of the following components: a policy engine 502, a QoE monitoring engine 504, a point of presence (PoP) selector 506, and/or an LSP tracker. As would be appreciated, the functionalities of these components may be combined or omitted, as desired. In addition, these components may be implemented on a singular device or in a distributed manner, in which case the combination of executing devices can be viewed as their own singular device for purposes of executing application experience optimization process 248.

In various embodiments, policy engine 502 may be used to control which online application (e.g., SaaS) applications are considered of interest/critical for purposes of optimizing their user experiences. To this end, policy engine 502 may interact with a user interface, thereby allowing an administrator to specify which applications should have their traffic be optimized in the backbone network. For instance, the administrator may specify to policy engine 502 that applications such as WebEx, Office365 Teams, Zoom, or other home-grown applications should have their traffic optimized using the techniques herein. In some instances, the list of possible applications for optimization may be identified through the use of deep packet inspection (DPI) of their traffic (e.g., protocol, port numbers, access list specifying specific server IP addresses, etc.). In addition to the application itself, other constraints managed by policy engine 502 may also relate to the volume of traffic. For instance, WebEx traffic from a point of presence (PoP) A to PoP B in the backbone network may only need to be optimized if its traffic volume exceeds 1 Gb/s.

In various embodiments, QoE monitoring engine 504 may be responsible for determining the QoE for all applications of interest, as specified by policy engine 502. In a first embodiment, QoE monitoring engine 504 may use a Layer-3 template to specify the Service Level Agreement (SLA) for each application of interest, using network-centric key performance indicators (KPIs). QoE monitoring engine 504 may obtain such KPIs from an SD-WAN controller (e.g., managed by the service provider), such as by retrieving the telemetry related to the traffic between the CE routers (e.g., the volume of traffic, type of application, delay, loss, jitter along the path, etc.).

For example, QoE monitoring engine 504 may monitor KPIs from the backbone network for voice traffic for Office365 Teams, WebEx, etc., and enforce hard thresholds for the maximum values of the measured delay, loss, and jitter. If such threshold(s) are crossed, this may be treated by QoE monitoring engine 504 as an SLA violation. In some embodiments, another parameter that QoE monitoring engine 504 may employ is maximum tolerable amount or percentage of time that an application of interest may exhibit SLA violations for a given amount of time. For instance, QoE monitoring engine 504 may impose a rule that voice traffic for a certain application should not exhibit an SLA violation more than 10% of the time within a given hour.

In another embodiment, QoE monitoring engine 504 may obtain the QoE metrics from an online application itself, such as through the use of an application programming interface (API) of that application. For instance, one API of Webex allows for the retrieval of QoE metrics on a per-meeting basis. More generally, such application QoE metrics may have the form of a scalar, such as a mean opinion score (MOS) between 0 and 5, a label or other information indicative of user feedback (e.g., ‘Good,’ ‘Degraded,’ ‘Bad,’ etc.), or any other information from the application indicative of the application experience from the standpoint of its users. In the case of QoE monitoring engine 504 obtaining QoE labels and enforcing a constrained having a temporal component, QoE monitoring engine 504 may evaluate the percentage of labels per category per unit of time that can be tolerated (e.g., by enforcing a maximum of 20% of “Bad” labels in a two hour time period).

Regardless of whether QoE monitoring engine 504 evaluates direct QoE metrics from the online application or those that rely on network KPIs as a proxy, QoE monitoring engine 504 may continue to evaluate these QoE metrics over time, to determine whether the application experience of the application is acceptable or unacceptable. When QoE monitoring engine 504 deems the QoE metrics unacceptable for a given application, it may then signal to PoP selector 506, to initiate corrective measures.

In various embodiments, PoP selector 506 may determine the ingress and egress nodes in the backbone network through which the traffic of the application of interest exhibiting unacceptable QoE flows. Such nodes are also often referred to as a point of presence (PoP), resulting in PoP selector 506 identifying the set of PoPs: {P_{ingress}, P_{egress}} associated with the application traffic. Indeed, consider the case of an SD-WAN: traffic is sent from an edge device (called CE—Customer Edge) connected to an ingress router of the Service Provider (called a PE (Provider Edge) or P routers).

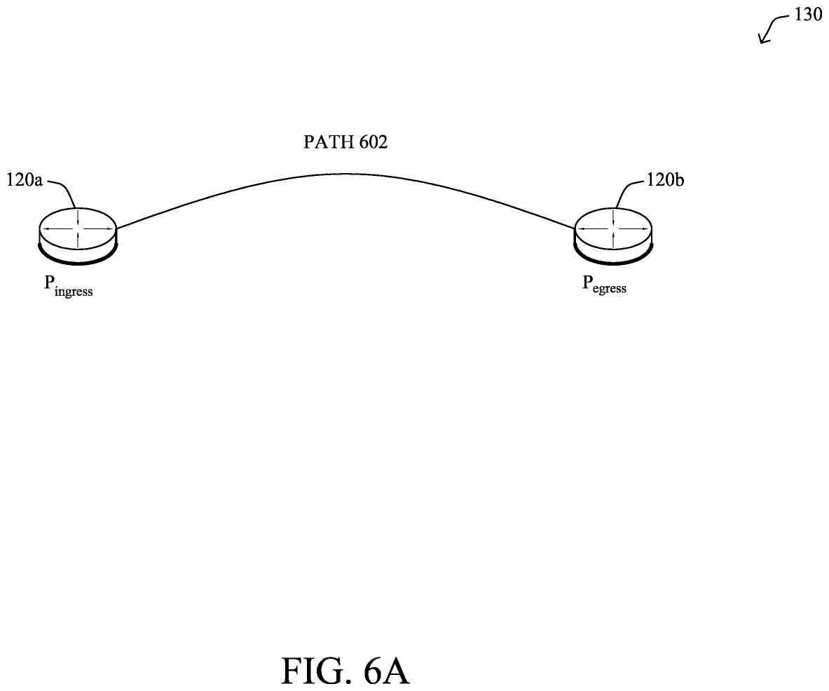

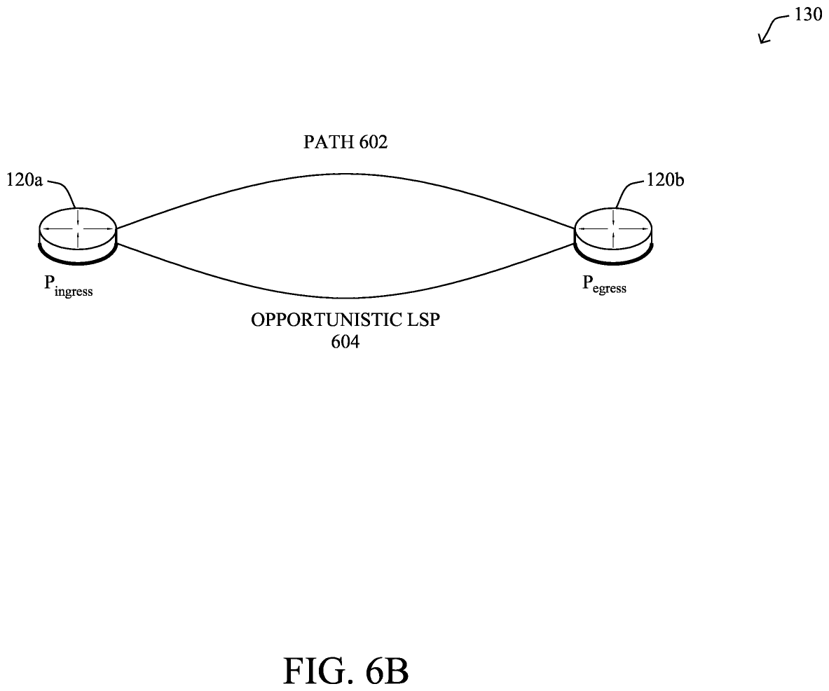

By way of example, consider the case shown in FIG. 6A of illustrative backbone network 130 having a path 602 connecting PE routers 120a-120b over which traffic for a particular online application is sent. Thus, the application traffic may enter illustrative backbone network 130 via router 120a, i.e., P_{ingress}, from a CE router, traverses path 602, and exits illustrative backbone network 130 via router 120b, i.e., P_{egress}. As would be appreciated, path 602 is typically selected using an IGP. In such a case, when QoE monitoring engine 504 determines that the QoE metrics for the application are unacceptable, PoP selector 606 may identify P_{ingress}, P_{egress} within illustrative backbone network 130.

Referring again to FIG. 5, PoP selector 506 may then send a custom path computation request 512 to the path computation element 510 for the backbone network, to trigger the computation of an alternate path (e.g., an opportunistic tunnel) that satisfies the application QoE. To this end, custom path computation request 512 may include any or all of the following:
The identity of the application whose QoE is unacceptable;
The current QoE for the application (e.g., the percentage of time outside of SLA, etc.);
The maximum tolerable SLA violation (e.g., for a certain span of time)
The addresses of Pingress and Pegress;
The amount of bandwidth consumed by the application traffic (e.g., using various statistical moment such as the average or other percentiles, distribution of probability of SLA violation as a function of time, etc.).

In turn, path computation element 510 may then identify an alternate path between Pingress and Pegress via which the application traffic could be sent. In the absence of an existing path (e.g., TEL SP) in the backbone network, path computation element 510 may compute a new path by running Dijkstra algorithm rooted at P_{ingress}. For instance, as shown in FIG. 6B and continuing the example of FIG. 6A, path computation element 510 may compute and schedule an opportunistic LSP 604 between routers 120a-120b for use by the application traffic of the online application whose QoE metrics are unacceptable.

At this point, multiple strategies may be used by path computation element 510, in various embodiments. In one embodiment, path computation element 510 may decide to schedule an opportunistic TE LSP to carry all traffic of interest, so as to restore an acceptable QoE. Thus, all of the application traffic of interest in FIG. 6B may be sent via opportunistic LSP 604 instead of path 602.

In further embodiments, path computation element 510 may take a less conservative approach, such as when the distribution of bandwidth is available (e.g., as a function of time). In such a cases, path computation element 510 may schedule a time-based TE LSP for use during peak hours to offload traffic and avoid SLA violations. For instance, opportunistic LSP 604 may only be scheduled for peak business hours.

In another embodiment, some of the application traffic may be offloaded to the alternate path (e.g., carried by the TEL SP), while some of the application traffic may continue to follow the existing path. For instance, only a portion of the application traffic sent via path 602 may be sent via the new, opportunistic LSP 604, instead. In yet another embodiment, path computation element 510 may use an incremental approach using a feedback loop consisting in offloading some traffic along the alternate path (the opportunistic TE LSP) and then get feedback from QoE monitoring engine 504, determine whether the QoE has again become acceptable. Here, the proportion of traffic steered onto opportunistic LSP 604 may be increased until QoE monitoring engine 504 indicates that the QoE for the application is again acceptable.

In some instances, a specific bandwidth pool may be used in the network for all opportunistic TE LSPs whose traffic is handled by a dedicated queue. Said differently, the backbone network may be managed to dedicate a percentage of all links capacities to carry critical traffic that must be protected from SLA violations. Note that path computation element 510 may alternatively use a set of opportunistic TE LSP to load balance the traffic between Pingress and Pegress.

As shown in FIG. 5, application experience optimization process 248 may further include LSP tracker 508 that is responsible for tracking all opportunistic TE LSPs scheduled in the network, along with the traffic carried by them, indications of any QoE improvements, etc. Such information can be used to improve decisions made by application experience optimization process 248 in the future. For instance, if path computation element 510 had scheduled a TE LSP of 1 Mbps between P1 and P2 between 13:00 UTC and 18:00 UTC for a few days, it may directly provision the said path at 1 Mbps instead of gradually increasing the bandwidth as described above. In some circumstances, it may even pre-provision the path at 12:59 UTC, similarly to what predictive networks do.

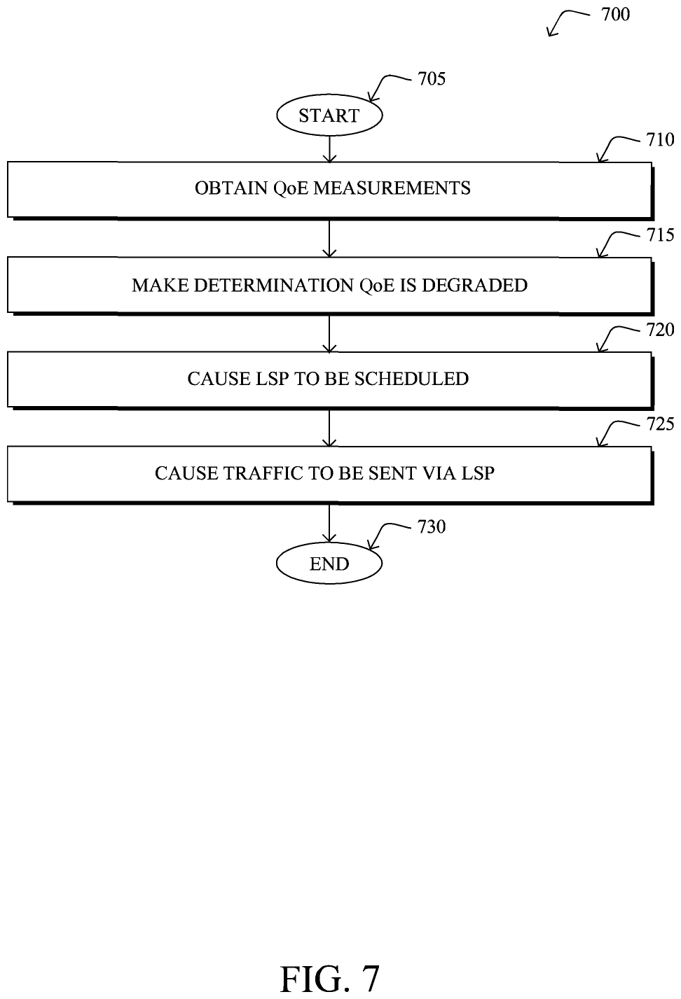

FIG. 7 illustrates an example simplified procedure 700 (e.g., a method) to schedule opportunistic LSPs in a backbone network to ensure acceptable application experience, in accordance with one or more embodiments described herein. For example, a non-generic, specifically configured device (e.g., device 200), such as controller for a network (e.g., an SDN controller or other device in communication therewith, a networking device, a path computation engine, etc.), may perform procedure 700 by executing stored instructions (e.g., application experience optimization process 248). The procedure 700 may start at step 705, and continues to step 710, where, as described in greater detail above, the device may obtain quality of experience measurements for an online application (e.g., an SaaS application) having application traffic conveyed via a first path in a backbone network between an ingress point and an egress point in the backbone network. In various embodiments, the first path is an Interior Gateway Protocol (IGP) path. In some embodiments, the quality of experience measurements are obtained by the device from the online application. For instance, such metrics may include a mean opinion score (MOS), feedback from users of the online application, or the like.

At step 715, as detailed above, the device may make a determination that the quality of experience metrics are indicative of degraded user experience with the online application. For instance, the device may do so based on the metrics crossing one or more predefined thresholds (e.g., indicating an SLA violation), the amount of time the metrics constituted an SLA violation within a certain amount of time, or based on any other defined criteria.

At step 720, the device may cause a label switched path to be scheduled between the ingress point and the egress point in the backbone network, as described in greater detail above. In some embodiments, the device may do so by sending a path computation request to the path computation engine that indicates one or more of: the online application, the ingress point and the egress point, the quality of experience metrics for the online application, or an amount of bandwidth consumed by the application traffic. In various embodiments, the label switched path is a Traffic Engineered Label Switched Path (TE-LSP) scheduled by a path computation engine for the backbone network. In one embodiment, the label switched path is scheduled during a time period identified as having a peak amount of traffic.

At step 725, as detailed above, the device may cause at least a portion of the application traffic for the online application to be sent via the label switched path instead of the first path. In one embodiment, the device may cause the portion of the application traffic sent via the label switched path to be increased until the quality of experience metrics are acceptable. In various embodiments, the device may also determine an amount of the application traffic sent via the label switched path that results in acceptable quality of experience metrics for the online application and cause the label switched path to be provisioned with a bandwidth equal. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for application experience optimization by opportunistically scheduling LSPs in a backbone network, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, quality of experience measurements for an online application having application traffic conveyed via a first path in a backbone network between an ingress point and an egress point in the backbone network;
making, by the device, a determination that the quality of experience metrics are indicative of degraded user experience with the online application;
causing, by the device, a label switched path to be scheduled between the ingress point and the egress point in the backbone network; and
causing, by the device, at least a portion of the application traffic for the online application to be sent via the label switched path instead of the first path.

2. The method as in claim 1, wherein the first path is an Interior Gateway Protocol (IGP) path.

3. The method as in claim 1, wherein the quality of experience measurements are obtained by the device from the online application.

4. The method as in claim 3, wherein the quality of experience measurements comprise a mean opinion score or feedback from users of the online application.

5. The method as in claim 4, further comprising:
determining, by the device, an amount of the application traffic sent via the label switched path that results in acceptable quality of experience metrics for the online application; and
causing, by the device, the label switched path to be provisioned with a bandwidth equal.

6. The method as in claim 1, wherein the label switched path is a source routed path.

7. The method as in claim 6, wherein the device causes the label switched path to be scheduled by:
sending a path computation request to a path computation engine that indicates one or more of: the online application, the ingress point and the egress point, the quality of experience metrics for the online application, or an amount of bandwidth consumed by the application traffic.

8. The method as in claim 1, wherein the label switched path is scheduled during a time period identified as having a peak amount of traffic.

9. The method as in claim 1, further comprising:
causing, by the device, the portion of the application traffic sent via the label switched path to be increased until the quality of experience metrics are acceptable.

10. The method as in claim 1, wherein the online application is a software-as-a-service (SaaS) application.

11. An apparatus, comprising:
one or more network interfaces;
a processor coupled to the one or more network interfaces and configured to execute one or more processes; and
a memory configured to store a process that is executable by the processor, the process when executed configured to:
obtain quality of experience measurements for an online application having application traffic conveyed via a first path in a backbone network between an ingress point and an egress point in the backbone network;
make a determination that the quality of experience metrics are indicative of degraded user experience with the online application;
cause a label switched path to be scheduled between the ingress point and the egress point in the backbone network; and
cause at least a portion of the application traffic for the online application to be sent via the label switched path instead of the first path.

12. The apparatus as in claim 11, wherein the first path is an Interior Gateway Protocol (IGP) path.

13. The apparatus as in claim 11, wherein the quality of experience measurements are obtained by the apparatus from the online application.

14. The apparatus as in claim 13, wherein the quality of experience measurements comprise a mean opinion score or feedback from users of the online application.

15. The apparatus as in claim 14, wherein the process when executed is further configured to:
determine an amount of the application traffic sent via the label switched path that results in acceptable quality of experience metrics for the online application; and
cause the label switched path to be provisioned with a bandwidth equal.

16. The apparatus as in claim 11, wherein the label switched path is a Traffic Engineered Label Switched Path (TE-LSP) scheduled by a path computation engine for the backbone network.

17. The apparatus as in claim 16, wherein the apparatus causes the label switched path to be scheduled by:
sending a path computation request to the path computation engine that indicates one or more of: the online application, the ingress point and the egress point, the quality of experience metrics for the online application, or an amount of bandwidth consumed by the application traffic.

18. The apparatus as in claim 11, wherein the label switched path is scheduled during a time period identified as having a peak amount of traffic.

19. The apparatus as in claim 11, wherein the process when executed is further configured to:
cause the portion of the application traffic sent via the label switched path to be increased until the quality of experience metrics are acceptable.

20. A tangible, non-transitory, computer-readable medium storing program instructions that cause a device to execute a process comprising:
obtaining, by the device, client attribute data for clients of an online application that access the online application via a plurality of points of presence in a network;
forming, by the device, a performance model that models an application experience metric for the online application as a function of the client attribute data for each of the plurality of points of presence;
selecting, by the device and using the performance model, a particular point of presence from among the plurality of points of presence to be used by a particular client to access the online application, based on its client attribute data; and
causing, by the device, the particular client to access the online application via the particular point of presence selected using the performance model.
